(19) United States
(12) Patent Application Publication
(10) Pub. No.: US 2016/0066080 A1
(43) Pub. Date: Mar. 3, 2016

(54) Earphone with Interchangeable Housing

(71) Applicant: Timothy Val Kolton, Arlington, TX (US)

(72) Inventor: Timothy Val Kolton, Arlington, TX (US)

(21) Appl. No.: 14/469,557

(22) Filed: Aug. 26, 2014

(51) Int. Cl. H04R 1/10

(52) U.S. Cl. CPC H04R 1/1091

(57) ABSTRACT

A customizable headphone includes an earphone having a body portion and a nozzle portion extending from the body portion. A decorative housing including an opening is designed to accommodate the body portion. The decorative housing also includes a releasable connection for affixing the decorative housing to the body portion, wherein the decorative housing encloses the body portion with the nozzle portion exposed. Upon releasing the releasable connection, a user may separate the decorative housing from the body portion and install a different decorative housing on the body portion as desired. The releasable connection can be a lip on the opening that corresponds to a channel on the body portion, and stabilizers either on the body portion or the decorative housing prevent the decorative housing from moving relative to the body portion.

### BACKGROUND

Headphones are well known in the art including both external, over-ear headphones that employ a headband or similar structure, and smaller in-ear earphones which are inserted into and supported by a user's ear. Due to earphones' diminished size and weight, because they are relatively inexpensive to manufacture, and often have an audio fidelity as good as or better than over-ear headphones, earphones are frequently preferred over headphones for everyday non-professional use, including when worn in public, while travelling or when users engage in sports activities.

Like most accessories (e.g., watches, jewelry, eyeglasses, etc.), users desire their headphones and earphones to harmonize aesthetically with their attire, to be fitting for their surroundings, or provide an appropriate appearance for a particular activity. For this reason users frequently purchase multiple sets of earphones or headphones to suit various uses and occasions. Due to the size and expense of over-ear headphones, owning multiple sets is both expensive and impractical.

Earphones have been developed having a wide variety of body designs, including variations in shape, color, and the materials comprising them. While owning multiple earphone sets is preferable to owning multiple headphones, users are still forced to coordinate and manage them, causing problems with organizing numerous earphones, frequently inadvertently losing a set, and having two or more sets tangle if stored together.

Another problem in maintaining numerous sets of differently shaped earphones is the redundancy of the non-aesthetic parts of each set. While a variety of external designs may be desired, the plugs, wires, transducers and other internal components are unnecessarily duplicated.

There is therefore a need for an earphone capable of a wide variety of external designs while having a single operational set of wires, a plug, and an earphone body. The need also exists for an earphone allowing users to quickly and easily select and switch between various different designs as desired, for instance to match changing attire. Finally, there is a need for an earphone offering numerous designs, which is also easy to manufacture and therefore less expensive. These and other problems in the art are addressed by an earphone having interchangeable housings as shown and described in the following summary, description, and claims.

### SUMMARY

A customizable earphone having a removable and interchangeable housing, allowing users to change the outward appearance of the earphone includes an earphone or set of earphones having a transducer for reproducing sound. Each earphone has two main components, a body portion and a nozzle portion extending from the body portion. Preferably, the nozzle portion includes a sound port for transmitting sound produced by the transducer to the user's ear. In addition to the body portion and the nozzle portion, the earphone includes a decorative housing. The decorative housing has an opening for accommodating the body portion, allowing a user to slide the body portion into the decorative housing.

The earphone also includes a releasable connection for affixing the decorative housing to the body portion, in order to hold the decorative housing onto the body portion while allowing the decorative housing to be easily removed in favor of installing a different decorative housing according to the user's preference. Preferably, the decorative housing encloses the body portion when affixed to the body portion, while leaving the nozzle portion exposed. This allows the customized portion of the earphone to be visible outside a user's ear, while permitting the customary fit of the earphone inside the user's ear.

If a user desires a different ornamentation for the earphone, such as to match clothing, jewelry or other attire, the user simply separates the decorative housing from the body portion by releasing the releasable connection and sliding the body portion from the opening of the decorative housing. Preferably, the nozzle portion will be fitted with a deformable tip, such as a conventional silicon earphone tip for inserting into a user's ear. The decorative housing is ideally shaped to rest adjacent the deformable tip when installed on the body portion, giving the illusion that the decorative housing is in fact the body portion of the earphone.

In order to ensure a smooth, releasable fit between the earphone and the deformable housing, and to aid in positioning the body portion within the deformable housing, the opening ideally closely matches the outer profile of the body portion. In one embodiment, the earphone may have a channel between the body portion and the nozzle portion. In such an arrangement, the decorative housing includes a lip at the opening designed to fit in the channel. Preferably the opening is sized to urge the lip into the channel under pressure when the body portion is inserted into the decorative housing.

In addition to the channel and lip releasable connection at the junction between the body portion and the nozzle portion of the earphone, the decorative housing also includes one or more stabilizing members on its interior. To prevent rocking or other undesirable movement of the body portion relative to the decorative housing, the stabilizing members are positioned to abut the body portion when fully inserted into the decorative housing and when the lip is engaged in the channel.

Since headphones, and in particular earphones, usually employ cabled connections between the earphone and a sound producing electronic device, the earphone may include a cable strain-relief extending from the body portion. The strain-relief is typically a rubber or similar resilient material sheathing the audio cable as it exits the body portion. To accommodate the strain-relief, the decorative housing preferably includes a slot extending from the opening. The slot is preferably sized and of a length that the cable strain-relief reaches the terminal end of the slot just as the lip of the opening seats in the channel on the body portion when the body portion is inserted into the decorative housing.

In order to use the earphone, an in-ear earphone is provided having a body portion and a nozzle portion. Also provided is a decorative housing and a connection between the earphone and the decorative housing. A user inserts the body portion through an opening on the decorative housing until the decorative housing is releasably affixed to the earphone and covers the body portion of the earphone. Preferably once the decorative housing is affixed to the earphone, the decorative housing is securely disposed adjacent the nozzle portion, giving the appearance that the decorative housing is, in fact, the body portion of the earphone. The earphone may then be inserted into the user's ear to listen to a desired audio.

When the user wishes to change the appearance of the earphone, the decorative housing is removed from the body portion. Typically, this is accomplished by sliding the body portion back through the opening, which may include sliding the strain-relief out of the slot adjacent the opening if a strain-relief is present. A new decorative housing may then be selected and inserted over the body portion. In various embodiments, multiple decorative housings may be provided with the earphone to offer users a wide variety of designs.

### BRIEF DESCRIPTION OF THE FIGURES

FIG. 1 is a perspective view of an earphone having an interchangeable decorative housing installed thereon.

FIG. 2 is a side view of the earphone without the decorative housing installed thereon.

FIG. 3 is a side view of the decorative housing.

FIG. 4 is a cutaway view of the decorative housing.

FIG. 5 is a front view of the decorative housing showing an opening.

FIG. 6 is a side view of the decorative housing installed on the earphone, including a cutaway detail view of a connection between the decorative housing and the earphone.

### REFERENCE NUMBERS

earphone 10
body portion 12
nozzle portion 14
sound port 16
decorative housing 18
opening 20
releasable connection 22
deformable tip 24
channel 26
lip 28
stabilizing member 30
cable strain-relief 32
slot 34
main portion 36
secondary portion 38
ear tip slot 40
ear tip 42
decorative indicia 44

### DESCRIPTION

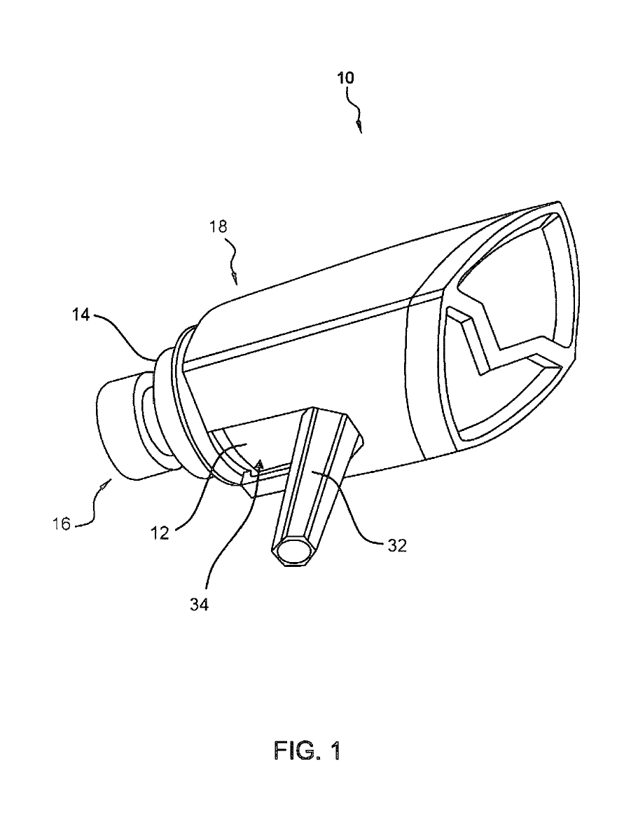

Referring now to FIG. 1, an earphone 10 comprises a body portion 12 and decorative housing 18 covering the body portion 12. The earphone 10 also comprises a nozzle portion 14 not covered by the decorative housing 18. The nozzle portion 14 includes a sound port 16 through which sound is transmitted to the user. Also shown in this embodiment, the earphone 10 includes a cable strain-relief 32 extending from the body portion 12 and the decorative housing 18 includes a slot 34 for accommodating the cable strain-relief 32.

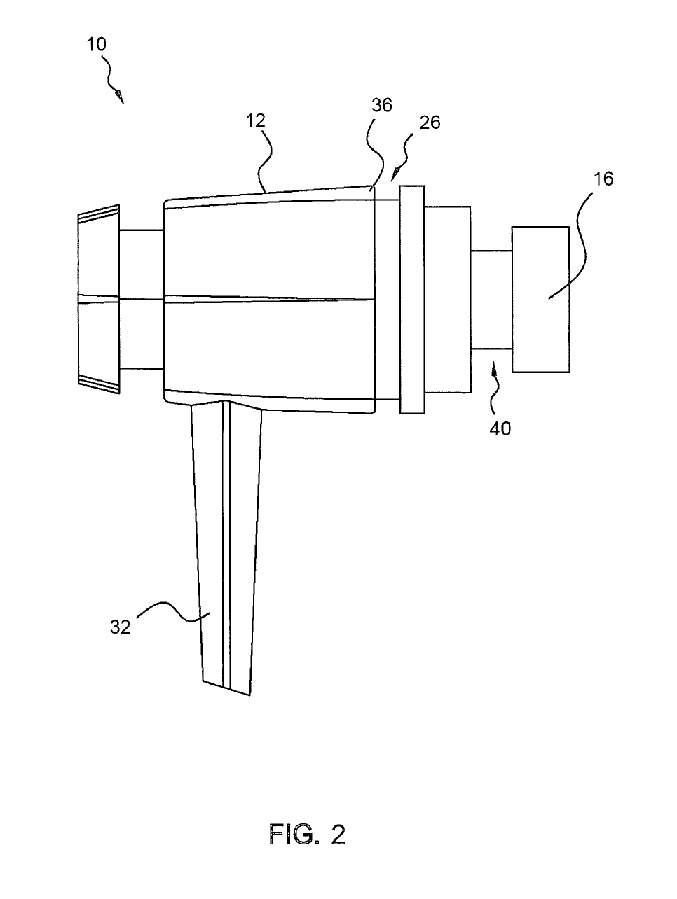

Referring to FIG. 2, a side view of the earphone 10 is shown without the decorative housing 18 (not shown). The body portion 12 of the earphone 10 includes a main portion 36 and a secondary portion 38 with a channel 26 disposed between them. The channel 26 is used to hold the decorative housing 18 in position relative to the earphone 10 when installed thereon. The earphone 10 nozzle portion 14 has a sound port 16 for directing sound into a user's ear, and an ear tip slot 40 for accommodating an ear tip 42 (not shown) and affixing it to the nozzle portion 14.

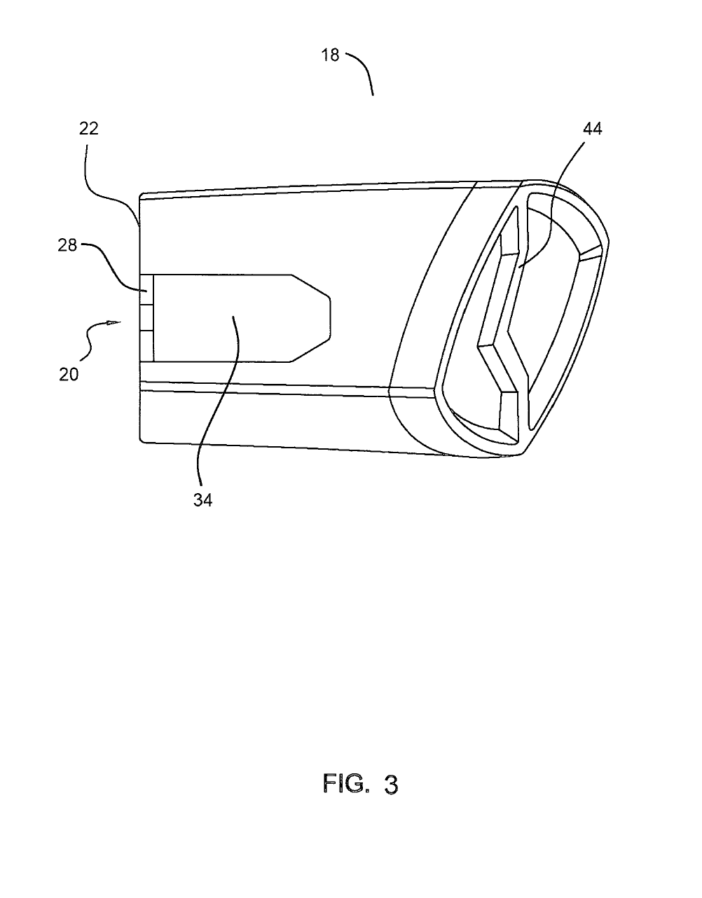

Referring to FIG. 3, a side view of the decorative housing 18 is shown. The decorative housing 18 may have an ornamental shape, and in addition may include decorative indicia 44 such as a design or logo. One end of the decorative housing 18 includes an opening 20 for receiving the body portion 12 (not shown). A slot 34 extends from the opening 20, allowing a user to slide the cable strain-relief 32 (not shown) into decorative housing 18 as well. Preferably the slot 34 is sized so that when the body portion 12 is inserted fully into the decorative housing 18, the cable strain-relief 32 reaches the terminal end of the slot 34.

Still referring to FIG. 3, the opening 20 preferably includes a releasable connection 22 adjacent the opening 20 for holding the body portion 12 relative to the decorative housing 18. In the illustrated embodiment, the releasable connection 22 includes a lip 28, slightly deformable due to the presence of the slot 34, thin walls, and resilient material comprising the deformable housing 18. The lip 28 is sized to encounter a channel 26 (not shown) on the body portion 12, holding it in position. Preferably the lip 28 and opening 20 are opposite any logo or indicia 44, thereby making the indicia 44 prominently visible when the earphone 10 bearing a decorative housing 18 is worn.

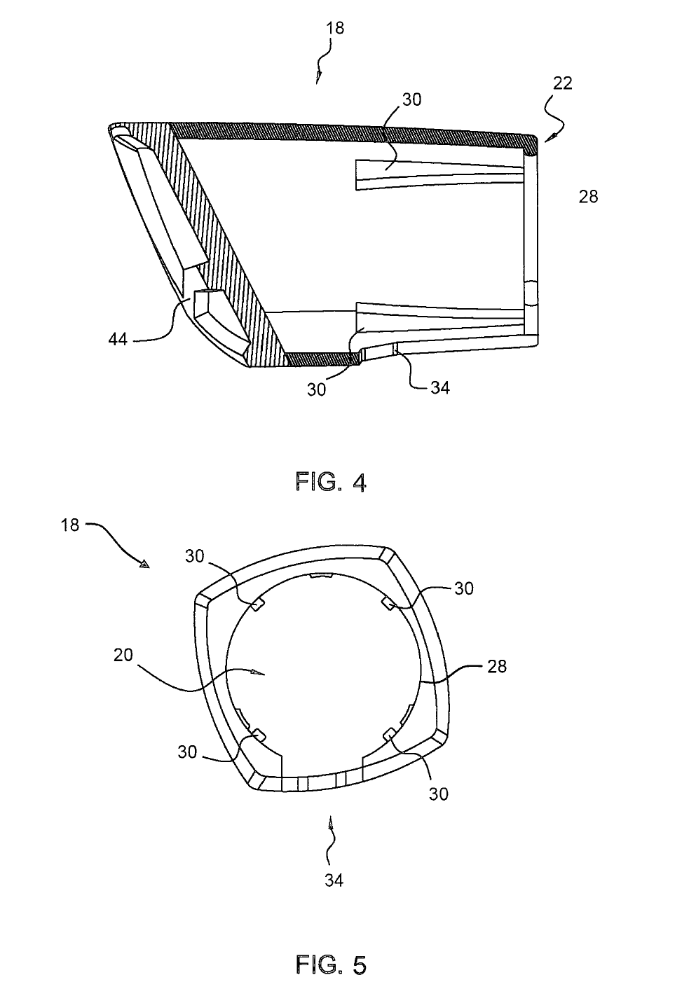

Referring to FIG. 4 a cutaway view of the decorative housing 18 shows its internal structure. Opposite the decorative indicia 44, the releasable connection 22 bearing the lip 28 is shown located at the opening 20. Also adjacent the opening 20 is a series of stabilizing members 30 extending inward from the decorative housing 18. The stabilizing members 30 are shaped to conform to the body portion 12 (not shown) of the earphone 10 (not shown). The stabilizing members 30 operate both as stops to prevent the body portion 12 from being inserted too deeply into the decorative housing 18, and to anchor the body portion 12 relative to the decorative housing 18 so the earphone 10 can be manipulated by the decorative housing 18 when inserting and removing the earphone 10 from a user's ear.

Referring to FIG. 5, a front view of the decorative housing 18 is shown. Due to the slot 34 being incorporated into the opening 20, the opening 20 can enlarge slightly under pressure as the body portion 12 (not shown) is inserted, causing the decorative housing 18 to lock onto the body portion 12 by virtue of the lip 28 “clicking” into the channel 26 (not shown) of the earphone 10 (not shown). Also shown in this view, the stabilizing members 30 face inward from the decorative housing 18, positioned to receive the body portion 12 (not shown) of the earphone 10.

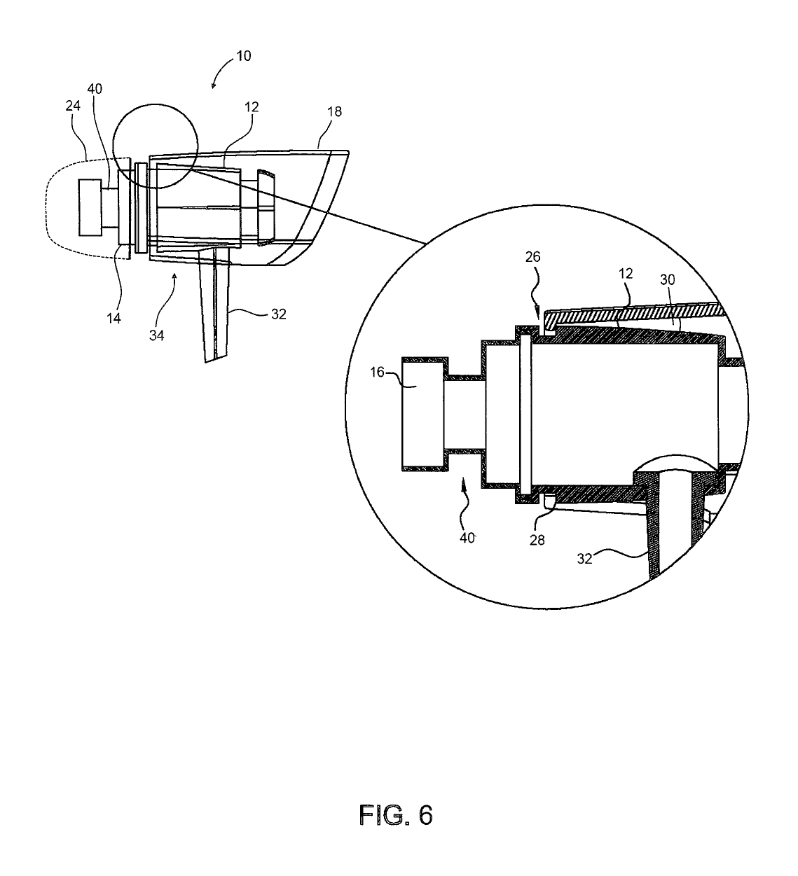

FIG. 6 shows a side view of earphone 10 with the decorative housing 18 installed on the body portion 12. Also shown in this view is an ear tip 42 installed over the nozzle portion 14 on the ear tip slot 40. A callout and cutaway view shows the connection between the body portion 12 and the decorative housing 18. As the decorative housing 18 is urged over the body portion 12, the body portion 12 slides into the decorative housing 18 and the cable strain-relief 32 slides into the slot 34.

The body portion 12 is sized slightly larger than the opening 20, such that the body portion 20 abuts the lip 28 before being fully inserted into the decorative housing 18. This causes the opening 20 to expand under pressure until the lip 28 reaches the channel 26, at which time the lip 28 “clicks” into place, restoring the opening 20 to its original size, and affixing the body portion 12 to the decorative housing 18 in a collar-like fit. To prevent further movement, the stabilizing members 30 are sized to engage the body portion 12 just as the lip 28 engages the channel 26. In this manner, the releasable connection 22 between the body portion 12 and the decorative housing 18 achieves a tight yet removable “click” fit.

To use the earphone 10, a user selects a decorative housing 18, preferably from among an available selection of decorative housings having different ornamental characteristics. The selected decorative housing 18 is slid over the body portion 12 until the releasable connection 22 “clicks” in place. The earphone 10 may then be used in the manner of a conventional set of in-ear earphones. When a user desires a different look, the user simply “clicks” the installed decorative housing 18 off of the body portion 12, selects a different decorative housing 18 and installs it on the body portion 12. In one contemplated embodiment, the outer appearance of the body portion 12 may comprise its own aesthetically pleasing design. In this manner, in addition to employing various decorative housings, a user may elect to use the earphone 10 just by itself.

The foregoing description of the preferred embodiment of the Invention is sufficient in detail to enable one skilled in the art to make and use the invention. It is understood, however, that the detail of the preferred embodiment presented is not intended to limit the scope of the invention, in as much as equivalents thereof and other modifications which come within the scope of the invention as defined by the claims will become apparent to those skilled in the art upon reading this specification.

What is claimed is:

1. A customizable headphone having a removable and interchangeable housing, comprising:
an earphone having a transducer for reproducing sound;
the earphone having a body portion, and having a nozzle portion extending from the body portion, wherein the nozzle portion comprises a sound port;
a decorative housing having an opening that accommodates the body portion;
a releasable connection that affixes the decorative housing to the body portion;
the decorative housing enclosing the body portion without enclosing the nozzle portion when the decorative housing is affixed to the body portion; and
wherein upon releasing the releasable connection, a user may separate the decorative housing from the body portion.

2. The headphone of claim 1 further comprising a deformable tip mounted on the nozzle portion for insertion into a user's ear.

3. The headphone of claim 2 wherein the decorative housing is adjacent the deformable tip when the decorative housing is installed on the body portion.

4. The headphone of claim 1 wherein the opening matches an outer profile of the body portion.

5. The headphone of claim 1 further comprising a channel between the body portion and the nozzle portion.

6. The headphone of claim 1 wherein the decorative housing comprises a lip at the opening, and wherein the opening is sized to urge the lip into the channel under pressure when the body portion is inserted into the decorative housing.

7. The headphone of claim 1 wherein the decorative housing comprises a stabilizing member inside the decorative housing that abuts the body portion when the body portion is inserted into the decorative housing.

8. The headphone of claim 1 further comprising a cable strain-relief extending from the body portion.

9. The headphone of claim 8 wherein the decorative housing comprises a slot extending from the opening that accommodates the cable strain relief.

10. An in-ear earphone having a removable and interchangeable housing, comprising:
a body portion enclosing a transducer and having a cable strain-relief extending from the body portion;
a nozzle portion, including a sound port configured to receive a deformable tip, extending from the body portion;
a decorative housing having an opening sized to accommodate the body portion in a pressure fit, and having a slot extending from the opening sized to accommodate the cable strain relief; and
the decorative housing having an internal stabilizing members securing the body portion in position relative to the decorative housing when the body portion is inserted into the decorative housing.

11. The in-ear earphone of claim 10 further comprising a channel between the body portion and the nozzle portion.

12. The in-ear earphone of claim 11 wherein the opening comprises a lip and is sized to urge the lip into the channel when the body portion is fully inserted into the decorative housing.

13. The in-ear earphone of claim 10 further comprising a deformable tip installed on the nozzle portion, the deformable tip adjacent the decorative housing.

14. A method of customizing a headphone comprising the steps of:
providing an in-ear earphone having a body portion and a nozzle portion;
providing a releasable connection between the body portion and the nozzle portion;
selecting a decorative housing having an opening;
inserting the body portion through the opening until the decorative housing is releasably affixed to the in-ear earphone covering the body portion and adjacent the nozzle portion; and
inserting the in-ear earphone bearing the decorative housing in a user's ear.

15. The method of claim 14 further comprising the step of removing the decorative housing from the in-ear earphone by sliding the body portion out of the opening.

16. The method of claim 14 further comprising the step of selecting a second decorative housing.

17. The method of claim 16 further comprising the step of sliding the second decorative housing over the body portion.

18. The method of claim 14 further comprising the step of providing multiple decorative housings.
